(19) United States
(12) Patent Application Publication
(10) Pub. No.: US 2016/0288109 A1
(43) Pub. Date: Oct. 6, 2016

(54) ZEOLITE FORMED BY EXTRUSION AND PELLETING WITH A HYDRAULIC BINDER HAVING IMPROVED MECHANICAL PROPERTIES AND PROCESS AND PREPARING SAME

(71) Applicant: IFP ENERGIES NOUVELLES, Rueil-Malmaison (FR)

(72) Inventors: Delphine BAZER-BACHI, Irigny (FR); Bogdan HARBUZARU, Valencia (FR); Eric LECOLIER, Chaville (FR)

(73) Assignee: IFP Energies nouvelles, Rueil-Malmaison (FR)

(21) Appl. No.: 15/037,162

(22) PCT Filed: Nov. 14, 2014
(86) PCT No.: PCT/FR2014/052907

§ 371 Date: May 17, 2016

(30) Foreign Application Priority Data
Nov. 18, 2013 (FR) 1361278

(51) Int. Cl. B01J 29/08; B01J 23/02; B01J 37/04; B01J 20/30; B01J 37/08; B01J 20/18; B01J 20/10; B01J 20/08; B01J 21/08; B01J 37/00

(52) U.S. Cl. CPC B01J 29/084; B01J 21/08; B01J 23/02; B01J 37/04; B01J 37/0018; B01J 37/08; B01J 20/18; B01J 20/103; B01J 20/08; B01J 20/3042; B01J 20/3007; B01J 20/3078

(57) ABSTRACT

The invention concerns a novel material comprising at least one zeolite shaped with a binder formulation comprising at least one hydraulic binder. The invention also concerns a process for the preparation of said material, comprising at least one step for mixing at least one powder of at least one zeolite with at least one powder of at least one hydraulic binder and at least one solvent, and a step for shaping the mixture obtained from the mixing step, preferably by pelletization or by extrusion.

The present invention relates to the field of zeolites, in particular that of shaping them for use in industrial applications for catalysis, storage or separation. More precisely, this invention relates to a novel formulation of a zeolite-based material using a binder formulation comprising at least one hydraulic binder. The present invention also concerns the preparation of the shaped zeolite.

### PRIOR ART

Throughout the remainder of the text, the term “zeolites” will be used for microporous crystalline solids the structure of which is based on a three-dimensional, regular concatenation of TO₄ tetrahedra, the element T generally being Si⁴⁺ or Al³⁺, but other elements such as B, P, Ge, Ga, Ti or Fe may also be incorporated, each oxygen being common to two tetrahedra. Molecules of water and cations (alkalis, alkaline-earths) compensating for the negative charge of the mineral framework are also present within the micropores. A non-exhaustive list of examples of zeolites which may be cited is given below: X zeolite, Y zeolite, ZSM-12, mordenite, A zeolite, P zeolite, beta zeolite, ZSM-5, EMC-2, mazzite, boggsite, gismondite, heulandite, chabasite, LTL, MCM-22, SAPO-31, AlPO-4, GaPO-4, VPI-5.

Zeolite shaping is generally tackled by employing processes for compaction, extrusion or granulation, with or without additives. The presence of additives is necessary in order to improve the qualities of the final material as regards mechanical strength. The additives generally used for shaping a zeolite are the hydroxide forms of alumina such as, for example, boehmite, silicas or clays. Many publications such as “Zeolites in Industrial Separation and Catalysis” Wiley page 70, “Studies in surface science and catalysis 53” Elsevier, page 509, the patents U.S. Pat. No. 7,594,995 B2, U.S. Pat. No. 4,579,831 A, U.S. Pat. No. 5,180,701 A and patent application US 2013 197290 describe these types of additives. These formulations with a conventional prior art binder have the disadvantage of requiring a calcining step which is carried out at a temperature of at least 400° C. in the case in which the additive used is a hydroxide of alumina, in order to obtain the desired mechanical strength.

In addition, these additives have to be added in quantities which are generally higher than 20% by weight in order to obtain the desired mechanical strength, but to the detriment of the pore volume of the material.

One aim of the present invention is to provide a novel material comprising at least one zeolite shaped with at least one hydraulic binder, preferably by pelletization in the presence of a solvent or by extrusion, said material having improved properties, in particular in terms of mechanical strength, and also being resistant to a rise in temperature compatible with the zeolite.

Another aim of the present invention is to provide a process for the preparation of said material in accordance with the invention, said material obtained having good mechanical strength and being adapted to the use thereof in the presence of a solvent and thus in an industrial process over long periods of time.

### SUMMARY OF THE INVENTION

The present invention concerns a material comprising at least one zeolite shaped with a binder formulation comprising at least one hydraulic binder.

The present invention also concerns a process for the preparation of said material in accordance with the invention, comprising at least the following steps:

a) a step for mixing at least one powder of at least one zeolite with at least one powder of at least one hydraulic binder and at least one solvent in order to obtain a mixture,
b) a step for shaping the mixture obtained from step a).

One advantage of the present invention is the provision of a preparation process for obtaining a material comprising at least one zeolite shaped with a binder formulation comprising at least one hydraulic binder, said material having improved properties, in particular as regards mechanical strength, and being resistant to a rise in temperature, which means that said material could be used in processes carried out in the presence of water or solvents and at relatively high temperatures.

Another advantage of the present invention is the provision, in a preferred embodiment, of a simplified process for the preparation of said material having enhanced properties, in particular in terms of mechanical strength, not requiring a calcining step after the shaping step, the absence of a calcining step having no effect on the properties of the material obtained.

Another advantage of the present invention is the provision of a process for the preparation of said material in accordance with the invention, which can be carried out irrespectively of the zeolite content, said process being capable of producing materials with good mechanical strength and which can therefore be used in a fixed bed.

### DETAILED DESCRIPTION

In accordance with the invention, said material comprises at least one zeolite shaped with a binder formulation comprising at least one hydraulic binder.

Said zeolite(s) used in the material of the present invention is(are) preferably selected from X, Y zeolites, ZSM-12, mordenite, A zeolite, P zeolite, beta zeolite, ZSM-5, mazzite, boggsite, gismondite, heulandite, chabasite, LTL, MCM-22, EMC-1, SAPO-31, AlPO-4, GaPO-4 and VPI-5, used alone or as a mixture.

Preferably, said zeolite(s) used in the material of the present invention is(are) selected from X, Y zeolites, ZSM-12, mordenite, A zeolite, P zeolite, beta zeolite, ZSM-5, SAPO-31, AlPO-4, GaPO-4 and VPI-5, used alone or as a mixture.

Said hydraulic binder(s) of the binder formulation with which said zeolite is shaped is(are) advantageously selected from hydraulic binders which are well known to the person skilled in the art. Preferably, said hydraulic binder(s) is(are) selected from Portland cement, high-alumina cements such as, for example, “Ciment Fondu”, Ternal, SECAR 51, SECAR 71, SECAR 80, sulphoaluminate cements, plaster, cements containing phosphate bonds such as, for example, magnesium phosphate cement, blast furnace slag cements and mineral phases selected from alite (Ca₃SiO₅), belite (Ca₂SiO₄), alumino-ferrite (or brownmillerite: with half unit formula Ca₂(Al,Fe³⁺)₂O₅)), tricalcium aluminate (Ca₃Al₂O₆), and calcium aluminates such as monocalcium aluminate (CaAl₂O₄), calcium hexoaluminate (CaAl₁₂O₁₈), used alone or as a mixture.

More preferably, the hydraulic binder is selected from Portland cement and high-alumina cements.

Said hydraulic binder(s) can be used to shape said material in accordance with the invention and provide it with good mechanical strength.

Said binder formulation comprising at least one hydraulic binder may also optionally comprise at least one source of silica.

In the case in which said binder formulation also comprises at least one source of silica, said source of silica is advantageously selected from precipitated silica and silica obtained from by-products like fly ash such as, for example, silico-alumina or silico-calcium particles, and silica fume.

Preferably, the size of the source of silica is below 10 μm, preferably below 5 μm, more preferably below 1 μm.

Preferably, the source of silica is in the amorphous or crystalline form.

Said binder formulation comprising at least one hydraulic binder may also optionally comprise at least one organic adjuvant.

In the case in which said binder formulation also comprises at least one organic adjuvant, said organic adjuvant is advantageously selected from cellulose derivatives, polyethylene glycols, mono-carboxylic aliphatic acids, alkylated aromatic compounds, sulphonic acid salts, fatty acids, polyvinyl pyrrolidone, polyvinyl alcohol, methylcellulose, polyacrylates, polymethacrylates, polyisobutene, polytetrahydrofuran, starch, polysaccharide type polymers (such as xanthan gum), scleroglucan, hydroxyethylated cellulose type derivatives, carboxymethylcellulose, lignosulphonates and galactomannan derivatives, used alone or as a mixture.

Said adjuvant may also be selected from any of the additives known to the person skilled in the art.

Preferably, said material has the following composition:
1% to 99% by weight, preferably 5% to 99% by weight, more preferably 7% to 99% by weight, and even more preferably 10% to 95% by weight of at least one zeolite,
1% to 99% by weight, preferably 1% to 90% by weight, more preferably 1% to 50% by weight, and even more preferably 1% to 20% by weight of at least one hydraulic binder,
0% to 20% by weight, preferably 0% to 15% by weight, more preferably 0% to 10% by weight, and even more preferably 0% to 5% by weight of at least one source of silica,
0% to 20% by weight, preferably 0% to 15% by weight, more preferably 0% to 10% by weight, and even more preferably 0% to 7% by weight of at least one organic adjuvant, the percentages by weight being expressed with respect to the total weight of said material and the sum of the contents of each of the compounds of said material being equal to 100%.

Said material in accordance with the present invention is advantageously in the form of extrudates, beads or pellets.

Said materials in accordance with the invention have improved mechanical properties, in particular in terms of mechanical strength, irrespective of the zeolite content involved, and are resistant to high temperatures, which means that said material could be used in processes in the presence of water or solvents and at relatively high temperatures, albeit limited by the temperature behaviour of the zeolite.

Said materials of the invention may therefore be employed for catalysis, gas storage and separation applications.

In particular, said materials in accordance with the invention have a mechanical strength, measured by the grain crush strength test, hereinafter denoted GCS, which is at least greater than 0.4 daN/mm, preferably at least greater than 0.9 daN/mm and more preferably at least greater than 1 daN/mm. These mechanical strength properties are maintained even after a heat treatment of up to 500° C. (when the associated zeolite is resistant to such temperatures) and for material compositions comprising up to 95% by weight of zeolite with respect to the total mass of said material.

The term “single pellet crush strength” means the mechanical strength of the material of the invention determined by the grain crush strength test (GCS). It concerns a standard test (ASTM standard D 4179-01) which consists of subjecting a material in the form of an object of millimetric proportions, such as a bead, a pellet or an extrudate, to a compressive force generating rupture. This test is thus a measurement of the tensile strength of the material. The analysis is repeated over a certain number of solid forms taken individually, typically over a number of solid forms which is in the range 10 to 200. The mean of the lateral rupture forces measured constitutes the average GCS, which is expressed in the case of granules in force units (N), and in the case of extrudates in force per unit length units (daN/mm or decaNewtons per millimetre of length of extrudate).

The present invention also concerns a process for the preparation of said material in accordance with the invention, comprising at least the following steps:

a) a step for mixing at least one powder of at least one zeolite with at least one powder of at least one hydraulic binder and at least one solvent in order to obtain a mixture,
b) a step for shaping the mixture obtained from step a).

### Step a):

In accordance with the invention, said step a) consists of mixing at least one powder of at least one zeolite with at least one powder of at least one hydraulic binder and at least one solvent in order to obtain a mixture.

Preferably, at least one source of silica and optionally at least one organic adjuvant are also mixed during step a).

Preferably, at least said source of silica and optionally said organic adjuvant may be mixed in the form of a powder or in solution in said solvent.

Said solvent is advantageously selected from water, ethanol, alcohols and amines. Preferably, said solvent is water.

In the context of the invention, it is entirely possible to envisage producing mixtures of a plurality of powders of different zeolites and/or different powdered sources of silica and/or different powders of hydraulic binders.

The order in which the powders of at least one zeolite, at least one hydraulic binder, optionally at least one source of silica and optionally at least one organic adjuvant, in the case in which these are mixed in the form of powders, is mixed with at least one solvent is irrelevant.

Said powders and said solvent may advantageously be mixed all at once.

The powders and solvent may also advantageously be added in alternation.

Preferably, said powders of at least one zeolite, at least one hydraulic binder, optionally at least one source of silica and optionally at least one organic adjuvant, in the case in which these are mixed in the form of powders, are initially pre-mixed in the dry state before introducing the solvent.

Said pre-mixed powders are then advantageously brought into contact with said solvent. In another embodiment, at least said source of silica and at least said organic adjuvant may initially be dissolved or suspended in said solvent when said solvent is brought into contact with the powders of at least one zeolite and at least one hydraulic binder. Contact with said solvent results in the production of a mixture which is then mixed.

Preferably, said mixing step a) is carried out by batch or continuous mixing.

In the case in which said step a) is carried out in batch mode, said step a) is advantageously carried out in a mixer, preferably equipped with a Z arm or with cams, or in any other type of mixer such as a planetary mixer, for example. Said mixing step a) can be used to obtain a homogeneous mixture of the powdered constituents.

Preferably, said step a) is carried out for a period in the range 5 to 60 min, preferably in the range 10 to 50 min. The rate of rotation of the aims of the mixture is advantageously in the range 10 to 75 rpm, more preferably in the range 25 to 50 rpm.

Preferably,
1% to 99% by weight, preferably 5% to 99% by weight, more preferably 7% to 99% by weight, and even more preferably 10% to 95% by weight of at least one powder of at least one zeolite,
1% to 99% by weight, preferably 1% to 90% by weight, more preferably 1% to 50% by weight, and even more preferably 1% to 20% by weight of at least one powder of at least one hydraulic binder,
optionally 0% to 20% by weight, preferably 0% to 15% by weight, more preferably 0% to 10% by weight, and even more preferably 0% to 5% by weight of at least one source of silica, preferably in the form of a powder,
optionally 0% to 20% by weight, preferably 0% to 15% by weight, more preferably 0% to 10% by weight, and even more preferably 0% to 7% by weight of at least one organic adjuvant, preferably in the form of a powder,
   are introduced in step a), the percentages by weight being expressed with respect to the total quantity of compounds, and preferably of powders introduced in said step a), and the sum of the quantities of each of the compounds, preferably of powders introduced in said step a), is equal to 100%.

### Step b):

In accordance with the invention, said step b) consists of shaping the mixture obtained from mixing step a).

Preferably, the mixture obtained from mixing step a) is advantageously shaped by extrusion or pelletization.

In the case in which shaping of the mixture obtained from step a) is carried out by extrusion, said step b) is advantageously carried out in a single or twin screw piston extruder.

In this case, an organic adjuvant may optionally be added to the mixing step a). The presence of said organic adjuvant facilitates shaping by extrusion. Said organic adjuvant has been described above and is introduced into step a) in the proportions indicated above.

In the case in which said preparation process is carried out continuously, said mixing step a) may be coupled with shaping step b) by extrusion in the same equipment. In accordance with this implementation, extrusion of the mixture which is also known as a “kneaded paste” may be carried out either by extruding directly from the end of the continuous twin-screw mixer for example, or by connecting one or more batch mixers to an extruder. The geometry of the die which gives the extrudates their shape may be selected from dies which are well known to the person skilled in the art. They may therefore, for example, be cylindrical, multilobed, grooved or slotted in shape.

In the case in which the mixture obtained from step a) is shaped by extrusion, the quantity of solvent added in mixing step a) is adjusted in a manner such as to obtain from this step, irrespectively of the variation employed, a mixture or a paste which does not flow but which is also not too dry in order to allow it to be extruded under suitable pressure conditions which are well known to the person skilled in the art and depend on the extrusion equipment used.

Preferably, said step b) for shaping by extrusion is operated at an extrusion pressure of more than 1 MPa, preferably in the range 3 MPa to 10 MPa.

In the case in which shaping of the mixture obtained from step a) is carried out by pelletization, the quantity of solvent employed in mixing step a) is adjusted so as to allow the pelletization dies to be filled easily and to allow pelletization under suitable pressure conditions which are well known to the person skilled in the art and which depend on the pelletization equipment used. Preferably, said step b) for shaping by pelletization is operated at a compressive force of more than 1 kN, preferably in the range 2 kN to 20 kN. The geometry of the pelletization die which shapes the pellets may be selected from dies which are well known to the person skilled in the art. Thus, for example, they may be cylindrical in shape. The dimensions of the pellets (diameter and length) are adapted to be suitable for the requirements of the process in which they will be used. Preferably, the pellets have a diameter in the range 0.3 to 10 mm and a diameter to height ratio which is preferably in the range 0.25 to 10.

The process for the preparation of said material of the invention may also optionally comprise a step c) for maturation of the shaped material obtained from step b). Said maturation step is advantageously carried out at a temperature in the range 0° C. to 300° C., preferably in the range 20° C. to 200° C. and more preferably in the range 20° C. to 150° C., for a period in the range 1 minute to 72 hours, preferably in the range 30 minutes to 72 hours, and more preferably in the range 1 h to 48 h and much more preferably in the range 1 h to 24 h.

Preferably, said maturation step is carried out in air, preferably in moist air with a relative humidity in the range 20% to 100%, preferably in the range 70% to 100%. This step may be used to hydrate the material properly, as is necessary for the hydraulic binder to set completely.

In accordance with a preferred embodiment, the shaped material obtained from shaping step b) and which has optionally undergone a maturation step c) does not undergo a final calcining step. In this case, the properties, in particular as regards mechanical strength, of the shaped material obtained from shaping step b) and optional maturation step c) are not modified and remain very high.

In accordance with another preferred embodiment, the shaped material obtained from shaping step b) and optional maturation step c) may also undergo a calcining step d) at a temperature in the range 50° C. to 500° C., preferably in the range 100° C. to 300° C., for a period in the range 1 to 6 h, preferably in the range 1 to 4 h. This calcining step is particularly useful for eliminating the organic adjuvants used in order to facilitate shaping of the material. The temperature of said calcining step d) is preferably in the range 50° C. to the degradation temperature of the zeolite or of the most fragile of the zeolites used in the material of the present invention, preferably in the range 150° C. to 350° C. for a period of time in the range 1 to 6 h, preferably in the range 2 to 4 h.

Said optional calcining step d) is advantageously carried out in a stream of gas comprising oxygen, for example; in a preferred example, the extrudates are calcined in dry air or with different levels of humidity, or indeed are heat treated in the presence of a mixture of gases comprising an inert gas, preferably nitrogen, and oxygen. The gaseous mixture used preferably comprises at least 5% by volume, or even more preferably at least 10% by volume of oxygen.

Said calcining step is advantageously carried out in the case in which the material obtained in accordance with the present invention is used as a catalyst support in processes operating at high temperature. In this case, it is advantageous to treat the materials used at the temperature to which they will be exposed during the process.

At the end of the process for the preparation of the material of the invention, the material obtained is in the form of extrudates or pellets.

However, it is not inconceivable that said materials obtained could then, for example, be introduced into equipment which could round their surfaces, such as a bowl granulator or any other equipment which could be used for spheronization thereof.

Said preparation process in accordance with the invention can be used to obtain materials in accordance with the invention with values for the mechanical strength, measured by the grain crush strength, of more than 0.4 daN/mm, preferably more than 0.9 daN/mm and more preferably more than 1 daN/mm, irrespective of the zeolite employed.

The material obtained at the end of the preparation process of the invention may be used for applications in catalysis, separation, purification, capture, storage, etc.

Said material is brought into contact with the gaseous feed to be treated in a reactor, which may be either a fixed bed reactor, or a radial reactor, or indeed a fluidized bed reactor.

In the case of an application in the fields of catalysis and separation, the expected value for the GCS is more than 0.9 daN/mm, preferably more than 1.0 daN/mm.

The examples below illustrate the invention without limiting its scope.

### EXAMPLES

In order to illustrate the invention, several preparation implementations are described, based on the use of a zeolite, in particular a Y zeolite with a Si/Al ratio or 2.5 prepared using the preparation process described in “Verified syntheses of zeolitic materials”, 2^{nd} Revised Edition 2001.

### Example 1

### Comparative

The Y zeolite powder was pelletized using a compression machine from MTS with instrumentation for pressure and displacement and provided with a system composed of a die and punches in order to produce compacted pellets. The diameter of the device selected for these tests was 4 mm. The die was supplied with powdered Y zeolite and a force of 7 kN was applied to the system.

The compacted pellets obtained had the following characteristics: S_{BET}=800 m²/g, GCS=0.7 daN/mm.

Analysis of the compacted pellets by X ray diffraction demonstrated a slight loss of crystallinity caused by this shaping method which also resulted in a reduction in the specific surface area (which was 850 m²/g for the powdered zeolite). The pellets were easily destroyed upon contact with a solvent (tests carried out with water and with ethanol).

### Example 2

### Y Zeolite Shaped by Extrusion in Accordance With the Invention

Preparation of a solid comprising 67% of Y zeolite: Y zeolite (67% by weight), silica (5.8%), Portland cement (Black label produced by Dyckerhoff) (22.4%) and methocel (K15M) (4.8%) powders were introduced and pre-mixed in a Brabender type mixer. The percentages by weight are expressed with respect to the total quantity of powders introduced. Water was added drop by drop until a paste was obtained and mixing was then continued for 20 minutes. The paste obtained was then extruded through a MTS type piston extruder using a 2 mm diameter cylindrical die.

The extrudates were stored under ambient conditions during the cement setting period (48 hours).

The extrudates obtained had a GCS value of 2.0 daN/mm and a S_{BET} of 575 m²/g.

### Example 3

### Y Zeolite Shaped by Extrusion in Accordance With the Invention: Effect of Post-Treatment

Preparation of solid comprising 67% of Y zeolite: the preparation was similar to that of Example 2, with the exception that the material shaped by extrusion then underwent a maturation step at a temperature of 20° C. for 48 h, in moist air comprising 100% by weight of water.

In this case, the mechanical strength was improved still further with a GCS of 2.7 daN/mm.

### Example 4

### Y Zeolite Shaped by Extrusion in Accordance With the Invention

Preparation of solid comprising 80.9% of Y zeolite: the preparation was identical to that of Example 2, with the exception that the proportions by weight of the various components were: 11.4% of Portland cement (Black label produced by Dyckerhoff), 2.9% of silica and 4.8% of methocel, and that the material shaped by extrusion then underwent a maturation step at a temperature of 20° C. for 48 h in moist air comprising 100% by weight of water.

The extrudates obtained had a GCS value of 1.9 daN/mm and a S_{BET} of 685 m²/g.

### Example5

### Y Zeolite Shaped by Pelletizing in Accordance With the Invention

Powders of Y zeolite (90% by weight), Portland cement (Black label produced by Dyckerhoff) (5%) and methocel (K15M) (5%) were introduced and pre-mixed in a mixer from Brabender with 10% of the total weight of powder and water for 15 minutes. The mixture obtained was pelletized using a compression machine from MTS with instrumentation for pressure and displacement and provided with a system composed of a die and punches in order to produce compacted pellets. The diameter of the device selected for these tests was 4 mm. A force of 7 kN was applied to the system. The material shaped by pelletization then underwent a step for maturation at a temperature of 20° C. for 4 days in moist air comprising 100% by weight of water. The compacted pellets obtained had the following characteristics: S_{BET}=760 m²/g, GCS=1 daN/mm.

The pellets were not destroyed in contact with a solvent (tests carried out with water and ethanol).

### Example 6

### Y Zeolite Shaped by Extrusion in Accordance With the Invention

Preparation of solid comprising 95% of Y zeolite: the preparation was identical to that of Example 2, with the exception that the proportions by weight of the various components were: 4% of Portland cement (Black label produced by Dyckerhoff) and 1% of methocel, and that the shaped material then underwent a maturation step at a temperature of 20° C. for 48 h in moist air comprising 100% by weight of water.

The extrudates obtained had a GCS value of 1 daN/mm and a S_{BET} of 800 m²/g.

1. A material comprising at least one zeolite shaped with a binder formulation comprising at least one hydraulic binder.

2. The material according to claim 1, in which said zeolite is selected from X, Y zeolites, ZSM-12, mordenite, A zeolite, P zeolite, beta zeolite, ZSM-5, mazzite, boggsite, gismondite, heulandite, chabasite, LTL, MCM-22, EMC-2, SAPO-31, AlPO-4, GaPO-4 and VPI-5, used alone or as a mixture.

3. The material according to claim 1, in which said hydraulic binder is selected from Portland cement, high-alumina cements, sulphoaluminate cements, plaster, phosphate bonded cements, blast furnace slag cements and mineral phases selected from alite (Ca₃SiO₅), belite (Ca₂SiO₄), alumino-ferrite (or brownmillerite: with half unit formula Ca₂(Al,Fe³⁺)₂O₅)), tricalcium aluminate (Ca₃Al₂O₆), calcium aluminates such as monocalcium aluminate (CaAl₂O₄), and calcium hexoaluminate (CaAl₁₂O₁₈), used alone or as a mixture.

4. The material according to claim 3, in which the hydraulic binder is selected from Portland cement and high-alumina cements.

5. The material according to claim 1, in which said binder formulation also comprises at least one source of silica.

6. The material according to claim 1, in which said binder formulation also comprises at least one organic adjuvant selected from cellulose derivatives, polyethylene glycols, mono-carboxylic aliphatic acids, alkylated aromatic compounds, sulphonic acid salts, fatty acids, polyvinyl pyrrolidone, polyvinyl alcohol, methylcellulose, polyacrylates, polymethacrylates, polyisobutene, polytetrahydrofuran, starch, polysaccharide type polymers, scleroglucan, hydroxyethylated cellulose type derivatives, carboxymethylcellulose, lignosulphonates and galactomannan derivatives, used alone or as a mixture.

7. The material according to claim 1, in which said material has the following composition:
1% to 99% by weight of at least one zeolite,
1% to 99% by weight of at least one hydraulic binder,
0% to 20% by weight of at least one source of silica,
0% to 20% by weight of at least one organic adjuvant, the percentages by weight being expressed with respect to the total weight of said material and the sum of the contents of each of the compounds of said material being equal to 100%.

8. The material according to claim 7, in which said material has the following composition:
10% to 95% by weight of at least one zeolite,
1% to 20% by weight of at least one hydraulic binder,
0% to 5% by weight of at least one source of silica,
1% to 7% by weight of at least one organic adjuvant, the percentages by weight being expressed with respect to the total weight of said material and the sum of the contents of each of the compounds of said material being equal to 100%.

9. The material according to claim 1, in which said material is in the form of extrudates, beads or pellets.

10. A process for the preparation of the material according to claim 1, comprising at least the following steps:
a) a step for mixing at least one powder of at least one zeolite with at least one powder of at least one hydraulic binder and at least one solvent in order to obtain a mixture,
b) a step for shaping the mixture obtained from step a).

11. The preparation process according to claim 10, in which at least one source of silica is also mixed in during step a).

12. The preparation process according to claim 10, in which at least one organic adjuvant is also mixed in during step a).

13. The preparation process according to claim 10, in which said step b) is carried out by extrusion or by pelletization.

14. The preparation process according to claim 10, in which said preparation process also comprises a step c) for maturation of the shaped material obtained from step b), said maturation step being carried out at a temperature in the range 0° C. to 300° C., for a period in the range 1 hour to 48 hours.

15. The preparation process according to claim 14, in which said maturation step is carried out in air, preferably in moist air containing 20% to 100% by weight of water.

16. The preparation process according to claim 10, in which said shaped material obtained from shaping step b) and which has optionally undergone a maturation step c) does not undergo a final calcining step.

17. The preparation process according to claim 10, in which said preparation process also comprises a step d) for calcining at a temperature in the range 50° C. to 500° C., for a period in the range 1 to 6 h.
